(19) United States
(12) Patent Application Publication
(10) Pub. No.: US 2023/0383885 A1
(43) Pub. Date: Nov. 30, 2023

(54) PIPE FOR HEATING A CRYOGENIC LIQUEFIED GAS AND METHOD FOR PRODUCING THE SAME

(71) Applicant: Airbus Operations GmbH, Hamburg (DE)

(72) Inventors: Matthias Hegenbart, Ahlerstedt (DE); Peter Linde, Buxtehude (DE)

(21) Appl. No.: 18/198,961

(22) Filed: May 18, 2023

(30) Foreign Application Priority Data
May 24, 2022 (EP) 22175163.9

(51) Int. Cl. F16L 53/37; F16L 9/10; H05B 3/14; H05B 1/02

(52) U.S. Cl. CPC F16L 53/37; F16L 9/10; H05B 3/145; H05B 1/0244; H05B 2214/04; H05B 2203/017

(57) ABSTRACT

A pipe for heating a cryogenic liquefied gas, the pipe having a peripheral wall including a ply of one or more electrically conductive carbon fibers, the ply being configured and electrically connectable to a power supply such that the one or more carbon fibers are heated when power is supplied to the ply.

### TECHNICAL FIELD

The disclosure herein relates to a pipe for heating a cryogenic liquefied gas, a pipe system, a fuel propulsion system, and a method for producing a pipe for heating a cryogenic liquefied gas.

### BACKGROUND

In aeronautical fuel cell propulsion systems, hydrogen most commonly is stored in a liquid hydrogen tank, cooled to −253° C. (cryogenic liquefied hydrogen). In this storage form, the hydrogen occupies less volume than in gas form, and volume is scarce in aircrafts. In order to function in a fuel cell, the hydrogen needs to be heated up to approximately room temperature (RT). This heating needs to be carried out between the liquid hydrogen (LH2) and the fuel cell.

### SUMMARY

An object of the disclosure herein is to provide a device for converting cryogenic liquefied gas into gas that can be provided for a fuel cell propulsion system.

To achieve this object, the disclosure herein provides a pipe, a pipe system, a fuel cell propulsion system, and a method for producing a pipe.

Advantageous embodiments of the disclosure herein are disclosed herein.

In one aspect, the disclosure herein provides a pipe for heating a cryogenic liquefied gas, the pipe having a peripheral wall including a ply of one or more electrically conductive carbon fibers, the ply being configured and electrically connectable to a power supply in such a way that the one or more carbon fibers are heated when power is supplied to the ply.

Preferably, the one or more carbon fibers are coated with an electrically non-conductive material.

Preferably, the one or more carbon fibers are coated with a polymer resin.

Preferably, the one or more carbon fibers are coated with an epoxy resin.

Preferably, the peripheral wall further comprises a graphene layer.

Preferably, the graphene layer is arranged between an inner pipe region of the pipe and the ply.

Preferably, the one or more carbon fibers are arranged disconnected between end portions of the one or more carbon fibers.

Preferably, the end portions are electrically connectable to the power supply.

Preferably, the end portions extend out of the ply.

Preferably, the end portions of a plurality of carbon fibers are electrically connected into a bundle.

Preferably, the one or more carbon fibers are at least partially embedded in a matrix.

Preferably, the one or more carbon fibers that are embedded in the matrix, build a carbon fiber-reinforced polymer.

Preferably, the one or more carbon fibers are arranged in a substantially longitudinal direction of the pipe.

Preferably, the ply includes a plurality of carbon fibers arranged substantially in parallel to each other.

Preferably, the ply extends radially over the peripheral wall.

Preferably, the one or more carbon fibers are arranged at and/or around a circumference of the pipe.

Preferably, the ply is a part of a laminate that includes at least a further ply.

Preferably, the further ply includes one or more carbon fibers.

Preferably, the pipe is configured for converting cryogenic liquefied gas into gas.

Preferably, the pipe is configured for conducting gas and cryogenic liquefied gas.

Preferably, the cryogenic liquefied gas is cryogenic liquefied hydrogen.

Preferably, the gas is hydrogen.

In another aspect, the disclosure herein provides a pipe system including the pipe and a power supply electrically connected to the ply.

Preferably, the pipe system includes an electrical element for regulating an electric current through the ply.

Preferably, the pipe system includes a temperature measurer for measuring a temperature of the pipe.

In another aspect, the disclosure herein provides a fuel cell propulsion system, including the pipe system, the pipe being in fluid connection with a tank and a fuel cell device.

Preferably, the fuel propulsion system further includes a heat exchanger for transferring heat that is produced by the fuel cell device to the pipe system.

In another aspect, the disclosure herein provides an aircraft including the pipe, the pipe system and/or the fuel propulsion system according to any of the preceding embodiments.

In another aspect, the disclosure herein provides a method for producing a pipe for heating a cryogenic liquefied gas, the method comprising the steps:

Producing a ply including one or more electrically conductive carbon fibers, the ply being configured and electrically connectable to a power supply in such a way that the one or more carbon fibers are heated when power is supplied to the ply; and

Folding the ply to a pipe.

Preferably, the method further comprises the step:

Coating the carbon fibers with an electrically non-conductive material.

Preferably, the method further comprises the step:

Coating the carbon fibers with a polymer resin.

Preferably, the method further comprises the step:

Coating the carbon fibers with an epoxy resin.

Preferably, the method further comprises the step:

At least partially embedding the carbon fibers in a matrix.

Preferably, the method further comprises the step:

Building a carbon fiber-reinforced polymer.

Preferably, the method further comprises the step:

Arranging the one or more carbon fibers disconnected between end portions of the one or more carbon fibers.

Preferably, the method further comprises the step:

Arranging a plurality of carbon fibers substantially in parallel to each other.

Preferably, the method further comprises the step:

Folding the ply such that the one or more carbon fibers are arranged in a substantially longitudinal direction of the pipe.

Preferably, the method further comprises the step:

Arranging the one or more carbon fibers at and/or around a circumference of the pipe.

Preferably, the method further comprises the step:

Adding a graphene layer on the ply.

Preferably, the graphene layer is added by spraying graphene flakes and/or by applying a buckypaper on the ply.

Preferably, the method further comprises the step:

Electrically connecting end portions of a plurality of carbon fibers into a bundle.

Preferably, the method further comprises the step:

Electrically connecting the ply, a bundle and/or end portions of the one or more carbon fibers to a power supply.

Preferably, the method further comprises the step:

Adding further plies in order to build a laminate.

Preferably, the further plies are added by filament winding.

Embodiments of the disclosure herein preferably have the following advantages and effects:

Embodiments of the disclosure herein preferably provide a method and a device for heating liquid hydrogen in carbon fiber-reinforced polymer (CFRP) pipes to a temperature, reaching gas form, and to room temperature (RT), for use in a fuel cell, without any external heating source outside the pipe.

Preferred embodiments of the disclosure herein are advantageous, in particular, when main engines are electric and are obtaining their energy from a fuel cell that has not yet reached its operating temperature, such as at cold start of the fuel cell.

The heating of the liquid hydrogen can be achieved by one or more coated carbon fibers in the inside of a ply of the pipe, in which electric current can be running.

The heat can be transferred to the hydrogen via a graphene cover layer, that can transmit heat via surfaces the best.

Operational functions may be:
heating of liquid hydrogen in a pipe from an LH2 tank to a fuel cell at cold start;
contributing to heating in a pipe from an LH2 tank to a fuel cell; and/or
reducing size and weight of a heat exchanger.

It is preferred that the pipe is sufficiently tight to suppress permeation.

In preferred embodiments, the innermost layer of graphene can have multiple functions, such as:
transfer the heat to the hydrogen from the heated coated carbon fibers;
contribute to suppression of hydrogen permeation; and/or
contribute to suppress static electricity at fast filling through the pipe.

Embodiments of the disclosure herein preferably have the following advantages:
enabling heating of hydrogen in CFRP plies when no further heat source is available (e.g., at cold start of a fuel cell);
heat can be transferred directly to hydrogen via highly thermally conducting graphene layer;
the heat source may come from the inside of a CFRP laminate, from coated carbon fibers, which may be space and weight saving;
the device may assist heat exchanger at operating temperature which can reduce weight and size;
a graphene layer preferably conducts heat and contributes to suppress permeation; and/or
a graphene layer may also contribute to avoid static electricity at fast filling.

### BRIEF DESCRIPTION OF THE DRAWINGS

Embodiments of the disclosure herein are now explained in more detail with reference to the accompanying drawings of which:

FIG. 1 shows a comparative embodiment of a fuel cell propulsion system in which heat is applied to a pipe via a heat exchanger;

FIG. 2 shows a comparative embodiment of a pipe system in which heat is applied to a pipe via heating spiral;

FIG. 3 shows a fuel cell propulsion system including a pipe according to an embodiment of the disclosure herein;

FIG. 4 shows a sectional view of the pipe of according to an embodiment of the disclosure herein;

FIG. 5 shows an enlarged view of a peripheral wall of the pipe according to an embodiment of the disclosure herein;

FIG. 6 shows an embodiment of a carbon fiber; and

FIG. 7 shows a pipe system according to an embodiment of the disclosure herein.

### DETAILED DESCRIPTION

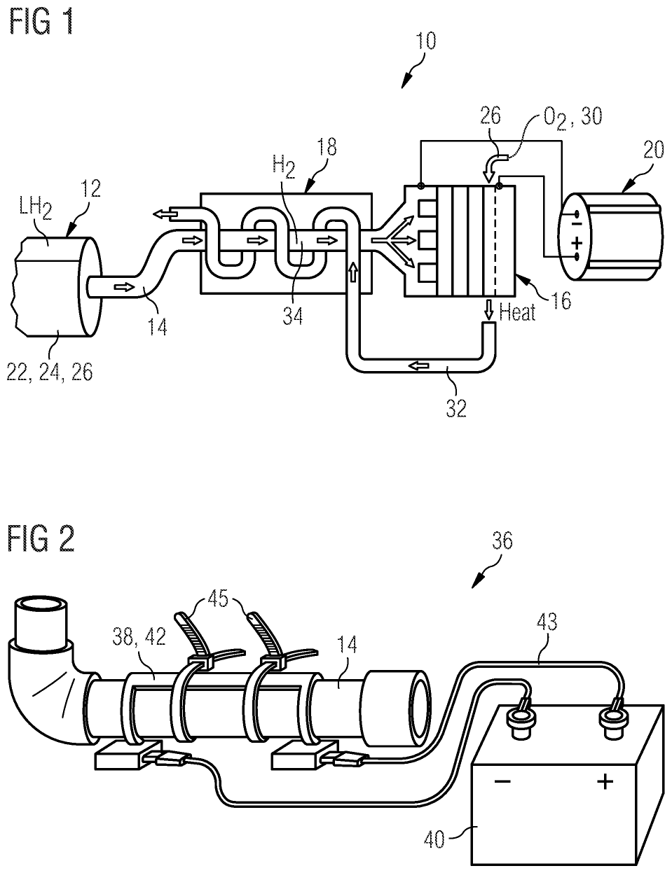

FIG. 1 shows a comparative embodiment of a fuel cell propulsion system 10.

The fuel cell propulsion system 10 includes a tank 12, a pipe 14, a fuel cell device 16, a heat exchanger 18, and an electric motor 20.

The tank contains a fuel 22 in form of a cryogenic liquefied gas 24.

The cryogenic liquefied gas 24 is preferably liquid hydrogen 26, but other cryogenic liquefied gases 24 which can be used as fuel 22 in the fuel cell device 16 are within the scope of the disclosure herein.

The pipe 14 is in fluid connection with the tank 12 and the fuel cell device 16.

In operation, the fuel cell device 16 converts the chemical energy of the fuel 22 and an oxidizing agent 26 into electricity. Heat is produced by the fuel cell device 16.

The oxidizing agent 26 in the case shown in FIG. 1 is oxygen 30 in gas form. The electricity is provided for the electric motor 20.

For operation, the fuel 22 that is provided for the fuel cell device 16, needs to be in gas form.

In the comparative embodiment of FIG. 1, a heat exchanger 18 transfers the heat produced by the fuel cell device 16 via a hot liquid pipe 32 to the pipe 14, so that in the pipe 14 the liquid hydrogen 26 is converted into hydrogen 34 in gas form.

Provided the liquid hydrogen 26 can obtain the energy from a heat source, this works well. However, if the fuel cell device 16 is cold, at start, no heat is produced by the fuel cell device 16 for several minutes. However, to function, the fuel cell device 16 needs hydrogen 34 warmed up to room temperature (RT).

FIG. 2 shows a comparative embodiment of a pipe system 36.

The pipe system 36 includes the pipe 14, a heating spiral 38, and a power supply 40.

The heating spiral 38 includes an electrically conductive wire 42, for instance a copper wire, that is clamped on top of the pipe 14 by clamps 45.

The heating spiral 38 is electrically connected to the power supply 40 via an electric cable 43.

When power is supplied to the heating spiral 38, the wire 42 is heated. The heat is transferred to the pipe 14, which, in turn, warms up the liquid hydrogen 26 in the pipe 14.

The heating spiral 38 includes a straight piece of the electrically conductive wire 42. Thus, the pipe 14 is heated mainly at one side thereof. The overall efficiency of this pipe system 36 is reduced.

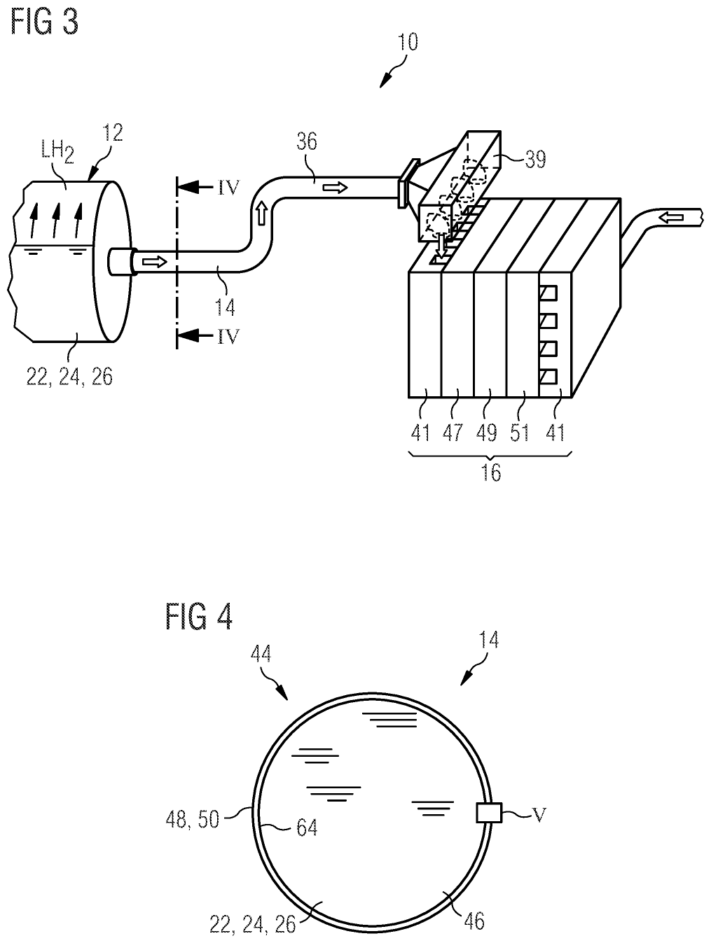

FIG. 3 shows a fuel cell propulsion system 10 according to an embodiment of the disclosure herein.

In the embodiment shown in FIG. 3, the fuel cell propulsion system 10 includes the tank 12, a pipe system 36, and the fuel cell device 16.

The fuel cell propulsion system 10 can additionally include a heat exchanger 18.

The fuel cell device 16 includes a block 39 for distributing hydrogen 34, a polar/bipolar plate 41, an anode 47, a membrane 49, a cathode 51, and another polar/bipolar plate 41.

The pipe system 36 includes a pipe 14 and a power supply 40 (not shown).

FIG. 4 shows a sectional view of the pipe 14 according to an embodiment of the disclosure herein. The cross-section is taken from line IV-IV in FIG. 3.

The pipe 14 includes a peripheral wall 44 surrounding an inner pipe region 46.

The peripheral wall 44 includes a laminate 48. In the present case, the laminate 48 is designed as a carbon fiber-reinforced polymer 50.

FIG. 5 shows an enlarged view of the peripheral wall 44 of the pipe 14. The enlarged view is taken from the box of FIG. 4.

The laminate 48 includes a (CFRP) ply 52 that is preferably arranged at an innermost region 53 of the peripheral wall 44.

The laminate 48 may include further (CFRP) plies 54 arranged in an outside region 55 of the peripheral wall 44.

The (innermost) ply 52 of the laminate 48 includes a plurality of carbon fibers 56. However, within the scope of the disclosure herein, the ply 52 may also include only a single carbon fiber 56.

The carbon fibers 56 are embedded in a matrix 57.

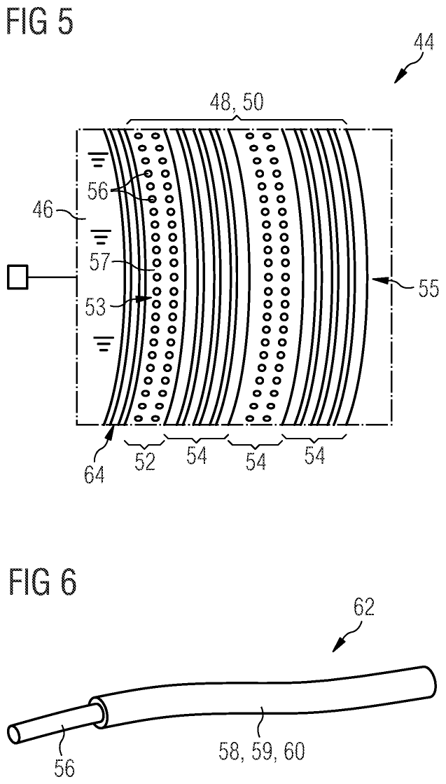

FIG. 6 shows an embodiment of one of the plurality of carbon fibers 56 of FIG. 5.

The one or more carbon fibers 56 are coated with an electrically non-conductive material 59. In the present case, the one or more carbon fibers 56 are coated with a polymer resin 58, namely an epoxy resin 60.

The carbon fiber 56 is electrically conductive, while the epoxy resin 60 is non-conductive.

The coated carbon fiber 62 can withstand temperatures of over 700° C. The epoxy resin 60 allows transmission of ions, but not of electrons. Thus, the epoxy resin 60 avoids short-circuits or current leakage, when a plurality of coated carbon fibers 62 could come into contact.

The carbon fibers 56 that are embedded in the matrix 57, build the carbon fiber-reinforced polymer 50.

Reference is made again to FIG. 5.

The peripheral wall 44 further comprises a graphene layer 64 that is arranged between the inner pipe region 46 and the ply 52.

The graphene layer 64 can have multiple effects. It can conduct heat, it can contribute to suppress permeation, and/or it can contribute to avoid static electricity when the pipe 14 is filled fast with liquid hydrogen 26.

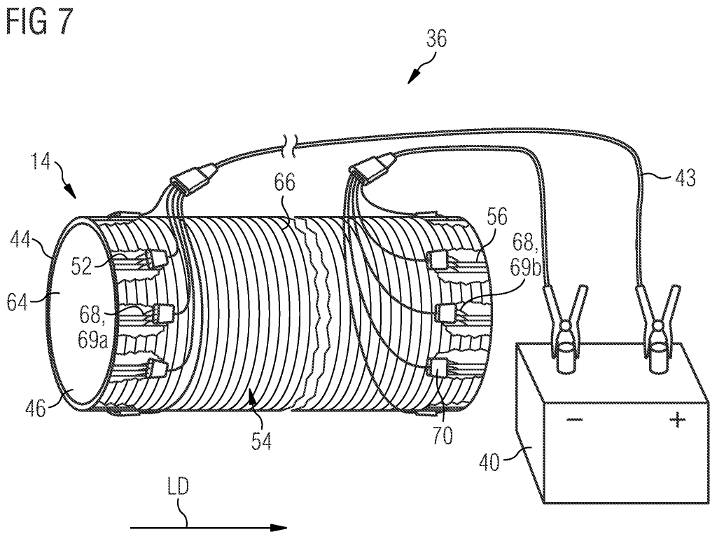

FIG. 7 shows a pipe system 36 according to an embodiment of the disclosure herein.

In contrast to the heating spiral 38 in FIG. 2, the ply 52 radially extends over the peripheral wall 44 of the pipe 14.

The ply 52 may also be radially extending over the entire peripheral wall 44.

In other words, the ply 52 may surround the inner pipe region 46 of the pipe 14.

The carbon fibers 56 of the ply 52 are thus arranged at and/or around a circumference 66 of the pipe 14.

In the embodiment shown in FIG. 7, the carbon fibers 56 are arranged in a longitudinal direction (LD) of the pipe 14. However, the carbon fibers 56 may also be arranged in any other direction, for example in a transversal direction of the pipe 14.

The carbon fibers 56 respectively include end portions 68.

The end portions 68 are located at opposite sides 69a, 69b of the carbon fibers 56.

The carbon fibers 56 are arranged disconnected between the end portions 68. Thus, no short-circuit is produced.

The end portions 68 may extend out of the ply 52.

The end portions 68 of some of the plurality of carbon fibers 56 are electrically connected into a bundle 70.

The bundles 70 are electrically connected to the power supply 40 such that the ply 52 is electrically connected to the power supply 40.

When power is supplied to the ply 52, the carbon fibers 56 are heated. Thus, the pipe 14 can heat the liquid hydrogen 26 to room temperature (RT). This may be advantageous especially at cold start of the fuel cell device 16.

When the fuel cell device 16 operates, a heat exchanger 18 may additionally transfer the heat that is produced by the fuel cell device 16 to the pipe 14. Due to the heated carbon fibers 56, the heat exchanger 18 may be reduced in size and weight.

In the following, a method for producing the pipe 14 according to an embodiment of the disclosure herein is described.

First, the plurality of carbon fibers 56 is provided and arranged disconnected between the end portions 68 and/or substantially in parallel to each other. This means, that the carbon fibers 56 are arranged in such a way that short-circuits are avoided in the ply 52.

The carbon fibers 56 are then coated with the polymer resin 58, for example with epoxy resin 60.

The carbon fibers 56 may be at least partially embedded in the matrix 57. The carbon fiber-reinforced polymer 50 is built and the ply 52 is produced.

The ply 52 is then covered with the graphene layer 64. This can be achieved by spraying graphene flakes on the ply 52, by applying a buckypaper on the ply 52 or by any other suitable method producing a graphene layer 64 on the ply 52.

The ply 52 is then folded up to the pipe 14.

Preferably, the ply 52 is folded such that the carbon fibers 56 are arranged in the longitudinal direction (LD) of the pipe 14. However, other folding directions are possible.

Further plies 54 may be added by filament winding in order to build the laminate 48.

The end portions 68 of some of the carbon fibers 56 may then be electrically connected into a bundle 70.

The ply 52 is then electrically connected to the power supply 40 via the electric cable 43.

To regulate the heating, a temperature measurer 72 may be placed on the pipe 14. The electric current through the carbon fibers 56 may be regulated by electrical elements 74, e.g., a resistor, inserted into the circuit.

Automated electric current regulation can be achieved by connecting the temperature measurer 72 with a micro controller.

According to the disclosure herein, it is possible to arrange the carbon fibers 56 at and/or around the circumference 66 of the pipe 14. Thus, efficient heating of the liquid hydrogen 26 may be achieved.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE NUMBERS

10 fuel cell propulsion system
12 tank
14 pipe
16 fuel cell device
18 heat exchanger
20 electric motor
22 fuel
24 cryogenic liquefied gas
26 liquid hydrogen
28 oxidizing agent
30 oxygen in gas form
32 hot liquid pipe
34 hydrogen in gas form
36 pipe system
38 heating spiral
39 block
40 power supply
41 plate
42 wire
43 electric cable
44 peripheral wall
45 clamp
46 inner pipe region
47 anode
48 laminate
49 membrane
50 carbon fiber-reinforced polymer (CFRP)
51 cathode
52 (innermost) ply
53 innermost region
54 (outer) plies
55 outside region
56 carbon fiber
57 matrix
58 polymer resin
59 electrically non-conductive material
60 epoxy resin
62 coated carbon fiber
64 graphene layer
66 circumference
68 end portion
69a, 69b side
70 bundle
72 temperature measuring means
74 electrical elements
CFRP carbon fiber-reinforced polymer
LD longitudinal direction
LH2 liquid hydrogen
RT room temperature

1. A pipe for heating a cryogenic liquefied gas, the pipe having a peripheral wall including a ply of one or more electrically conductive carbon fibers, the ply being configured and electrically connectable to a power supply such that the one or more carbon fibers are heated when power is supplied to the ply.

2. The pipe according to claim 1, wherein the one or more carbon fibers are coated with an electrically non-conductive material, or a polymer resin, or an epoxy resin.

3. The pipe according to claim 1, wherein the peripheral wall further comprises a graphene layer which is arranged between an inner pipe region of the pipe and the ply.

4. The pipe according to claim 1, wherein the one or more carbon fibers are arranged disconnected between end portions of the one or more carbon fibers.

5. The pipe according to claim 4, wherein the end portions are electrically connectable to the power supply and or the end portions of a plurality of carbon fibers are electrically connected into a bundle.

6. The pipe according to claim 1, wherein the one or more carbon fibers are at least partially embedded in a matrix for building a carbon fiber-reinforced polymer.

7. The pipe according to claim 1, wherein the one or more carbon fibers are arranged in a substantially longitudinal direction of the pipe and or the ply includes a plurality of carbon fibers arranged substantially in parallel to each other and or the ply extends radially over the peripheral wall.

8. The pipe according to claim 1, wherein the ply is a part of a laminate that includes at least a further ply of one or more carbon fibers.

9. The pipe according to claim 1, wherein the pipe is configured for converting cryogenic liquefied gas into gas and or for conducting gas and cryogenic liquefied gas, and wherein the cryogenic liquefied gas is cryogenic liquefied hydrogen, while the gas is hydrogen.

10. A pipe system including the pipe according to claim 1, a power supply electrically connected to the ply, and an electrical element for regulating an electric current through the ply and or a temperature measurer for measuring a temperature of the pipe.

11. A fuel cell propulsion system, including the pipe system according to claim 10, the pipe being in fluid connection with a tank and a fuel cell device.

12. The fuel propulsion system according to claim 11, further including a heat exchanger for transferring heat produced by the fuel cell device to the pipe system.

13. A method for producing a pipe for heating a cryogenic liquefied gas, the method comprising:
producing a ply including one or more electrically conductive carbon fibers, the ply being configured and electrically connectable to a power supply such that the one or more carbon fibers are heated when power is supplied to the ply; and
folding the ply to a pipe.

14. The method according to claim 13, further comprising:
coating the carbon fibers with an electrically non-conductive material, or a polymer resin, or an epoxy resin; and or
at least partially embedding the carbon fibers in a matrix for building a carbon fiber-reinforced polymer; and or
arranging the one or more carbon fibers disconnected between end portions of the one or more carbon fibers; and or
arranging a plurality of carbon fibers substantially in parallel to each other; and or
folding the ply such that the one or more carbon fibers are arranged in a substantially longitudinal direction of the pipe; and or
arranging the one or more carbon fibers at and or around a circumference of the pipe; and or
adding a graphene layer on the ply by spraying graphene flakes or by applying a buckypaper on the ply.

15. The method according to claim 13, further comprising:
electrically connecting end portions of a plurality of carbon fibers into a bundle; and or
electrically connecting the ply, a bundle and/or end portions of the one or more carbon fibers to a power supply; and or
adding further plies by filament winding in order to build a laminate.
